(19) United States
(12) Patent Application Publication
(10) Pub. No.: US 2025/0027637 A1
(43) Pub. Date: Jan. 23, 2025

(54) LIGHT ASSEMBLY

(71) Applicant: VISTA Manufacturing Inc., Elkhart, IN (US)

(72) Inventors: Alexander M. Tolen, Elkhart, IN (US); Peter A. McGlaughlin, Mishawaka, IN (US)

(21) Appl. No.: 18/740,090

(22) Filed: Jun. 11, 2024

Related U.S. Application Data
(60) Provisional application No. 63/514,895, filed on Jul. 21, 2023.

(51) Int. Cl. F21V 23/02; F21V 19/00; F21V 23/00; F21Y 105/18; F21Y 115/10; H02J 50/00; H02J 50/10; H02J 50/90

(52) U.S. Cl. CPC F21V 23/023; F21V 19/00; F21V 23/006; H02J 50/005; H02J 50/10; H02J 50/90; F21V 2200/20; F21Y 2105/18; F21Y 2115/10

(57) ABSTRACT

A light module includes a light-transmitting surface, a light source supported relative to the light-transmitting surface to direct to the light-transmitting surface when the light source is powered, an electrical circuit in electrical communication with the light source to direct current to the light source, and a wireless power receiving coil in electrical communication with the electrical circuit, the wireless power receiving coil for receiving wireless power from a wireless power transmitting coil supported remotely from the electrical circuit wherein when the wireless power receiving coil or loop is in close proximity to the wireless power transmitting coil or loop the electrical circuit will direct current to the light source.

This application claims the benefit of US Pro. App. Ser. No. 63/514,895, entitled LIGHT ASSEMBLY, which was filed Jul. 21, 2023 and is incorporated by reference herein in its entirety.

### TECHNICAL FIELD AND BACKGROUND

Light assemblies, including LED light assemblies, are typically powered through physical, wired connections. Installing a light assembly in an application where a hole must be drilled in the mounting surface, in order to route the wires from the light assembly to the power source, can be labor intensive. In cases where the hole must be sealed to prevent water intrusion, this installation method risks damage to the mounting surface and to the light assembly that is being mounted. Further, in the event the light assembly is to be moved, the hole must be repaired, which in some cases, such as on a wood mounting surface, it may be impossible to restore the mounting surface to its predrilled appearance.

### SUMMARY

Accordingly, in one embodiment, a light module for mounting on one side of a mounting surface includes a light-transmitting surface, a light source supported relative to the light-transmitting surface to direct to the light-transmitting surface when the light source is powered, an electrical circuit in electrical communication with the light source to direct current to the light source, and a wireless power receiving coil. The wireless power receiving coil is in electrical communication with the electrical circuit and is for receiving wireless power from a wireless power transmitting coil supported on oppose side of the mounting surface wherein when the wireless power receiving coil is in close proximity to the wireless power transmitting coil the electrical circuit will direct current to the light source.

In one aspect, the light module further includes a housing, which includes the electrical circuit.

In further aspect, the housing further includes the light emitting surface.

In any of the above, the light-emitting surface may be provided by a light guide plate (LGP).

In any of the above, the light module further includes a circuit board, wherein the electrical circuit and the wireless power receiving coil are supported or formed on the circuit board.

In a further aspect, the wireless power receiving coil comprises a copper trace wireless power receiving coil printed on the circuit board.

In any of the above, the light source may comprise a plurality of LEDS.

In a further aspect, when the light emitting surface is provided by a light guide plate (LGP), the LEDS may be mounted adjacent the peripheral edge of the light guide plate.

In any of the above, the light module may also include an alignment device to align the wireless power receiving coil with the wireless power transmitting coil, with the alignment device optionally comprising a magnet, such as a magnetic ring.

In any above, the electrical circuit may comprise an LC circuit with a capacitor and the wireless power receiving coil.

According to another embodiment a light module includes a housing for mounting to a mounting surface. The housing includes a light emitting surface and a light source supported and sealed in the housing for directing light through the light emitting when the light source is powered. The housing also supports an electrical circuit electrically coupled to the light source for directing current to the light source, which is also sealed in the housing, and a wireless power receiving coil electrically coupled to the electrical circuit. The wireless power receiving coil is also supported and sealed in the housing for receiving wireless power from a wireless power transmitting coil supported exteriorly of the housing wherein when the wireless power receiving coil is in close proximity to the wireless power transmitting coil the electrical circuit will direct current to the light source.

One aspect, the light emitting surface is provided by a light guide plate (LGP).

In any of the above, the light module further includes a circuit board, wherein the electrical circuit and the wireless power receiving coil are supported or formed on the circuit board. For example, in one aspect, the wireless power receiving coil may comprise a copper trace wireless power receiving coil printed on the circuit board.

In any the above, the light source comprises a plurality of LEDs. Further, when the light emitting surface is provided by a light guide plate (LGP), the LEDs may be mounted adjacent the peripheral edge of the light guide plate.

In any of the above, the light module may also include an alignment device to align the wireless power receiving coil with the wireless power transmitting coil. For example, the alignment device may comprise a magnet, such a magnetic ring.

In any of the above, the electrical circuit comprises an LC circuit with a capacitor and the wireless power receiving coil, and an AC to DC converter.

In yet another embodiment, a light assembly includes any of the light modules described above in combination with a transmitter apparatus. The transmitter apparatus includes a driver circuit for electrically coupling to a power source. The transmitter apparatus further includes a wireless power transmitting coil electrically coupled to the driver circuit. Thus, when the wireless power receiving coil of the light module is in close proximity to the wireless power transmitting coil of the transmitter apparatus, and the driver circuit of the transmitter apparatus is electrically coupled to a power source, the electrical circuit of the light module will direct current to the light source.

In one aspect, the driver circuit comprises an LC circuit with a capacitor and the wireless power transmitting coil.

In any of the above light modules, the light module further includes a housing, which encloses the light emitting surface and the electrical circuit. In a further aspect, the light source, the electrical circuit, and the receiving circuit are sealed in the housing.

In any of the above light assemblies, the light-emitting surface of the light module is provided by a light guide plate (LGP).

In any the above light assemblies, the light module further includes a circuit board, wherein the electrical circuit and the wireless power receiving coil are supported or formed on the circuit board.

In any of the above, the light source may comprise a plurality of LEDs. For example, when the light emitting surface is provided by a light guide plate (LGP), the LEDs may be mounted adjacent the peripheral edge of the light guide plate.

In any of the above, the light assembly may include an alignment device to align the wireless power receiving coil with the wireless power transmitting coil, and optionally the alignment device comprises a magnet, such as a magnetic ring.

In any of the above light assemblies, the light assembly may further include a transmitter housing, which supports and encloses the driver circuit and the wireless power transmitting coil.

In yet a further aspect, the driver circuit may include electrical leads extending from the transmitter housing to electrical couple the driver circuit to an external power source, and the housing includes a moisture seal about the electrical leads, such as a grommet seal.

Accordingly, the present disclosure describes a light assembly that can be installed without the need for drilling wiring holes.

### DETAILED DESCRIPTION OF THE DRAWINGS

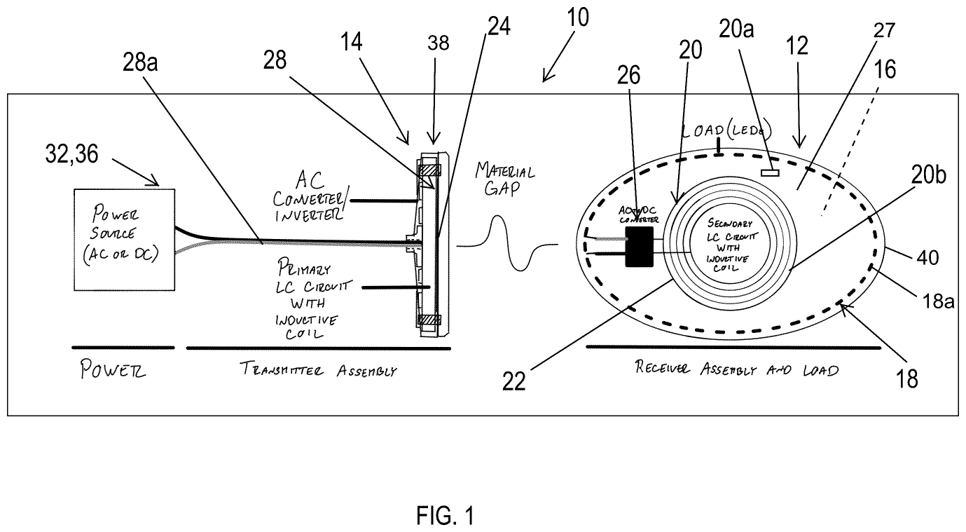

FIG. 1 is a schematic view of a light assembly with a light module and a transmitter apparatus;

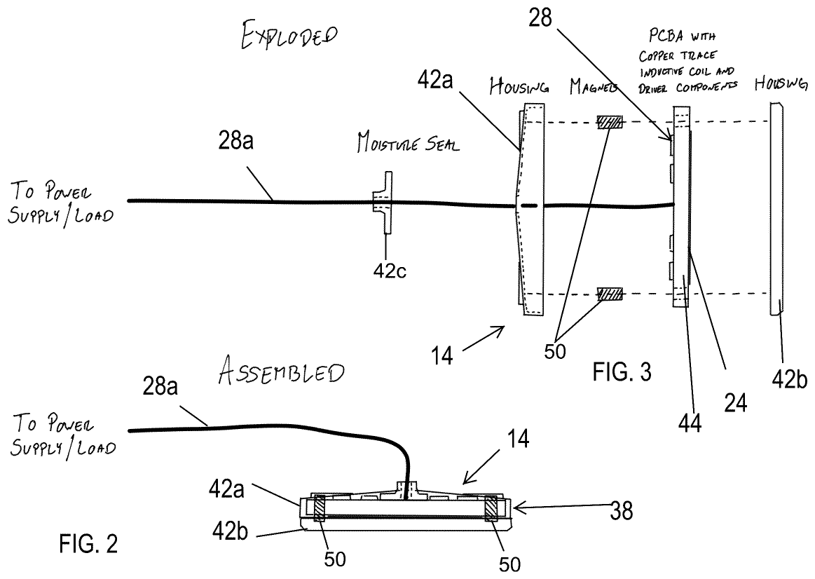

FIG. 2 is a side elevation view of a transmitter apparatus of the light assembly of FIG. 1;

FIG. 3 is an exploded side view of the transmitter apparatus of FIG. 2;

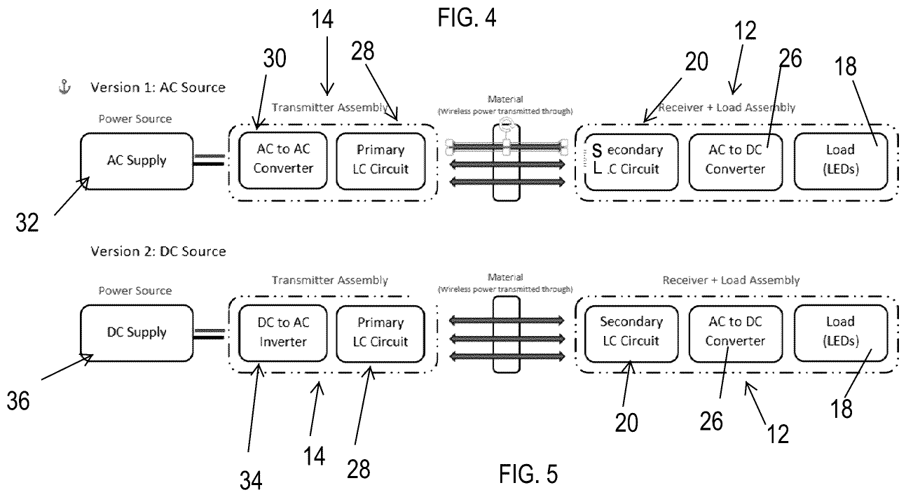

FIG. 4 is a schematic of a light circuit of the light assembly when powering the light assembly by an AC source;

FIG. 5 is a schematic of a light circuit up light assembly when powering the light assembly by DC source;

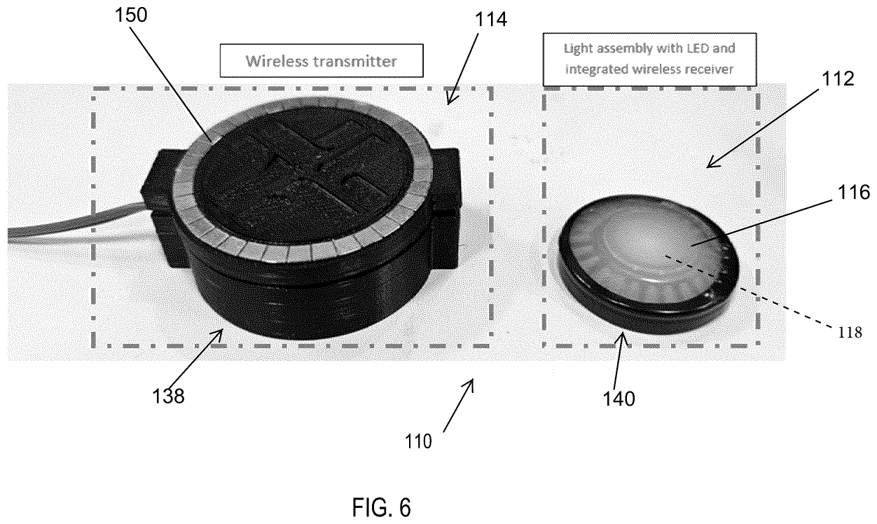

FIG. 6 is a perspective view of a light assembly;

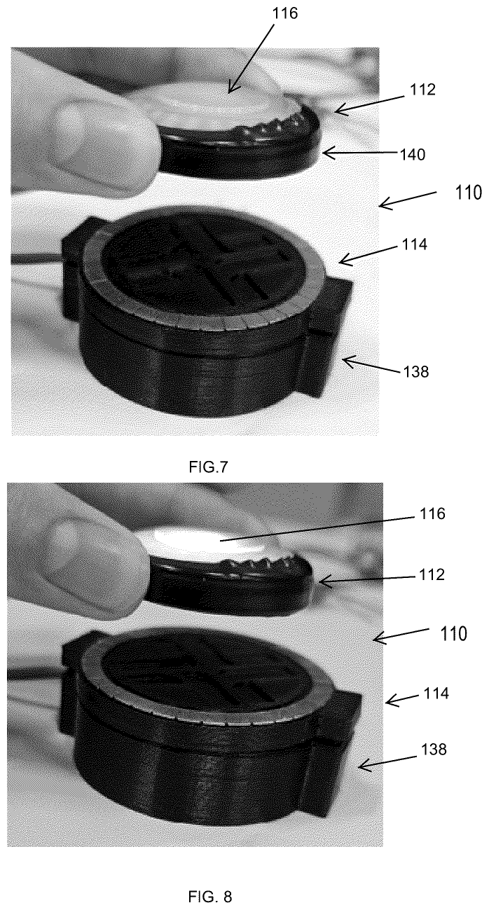

FIG. 7 is a similar view to FIG. 6 illustrating the light module adjacent the transmitter apparatus;

FIG. 8 is a similar view to FIG. 7 showing the light module in close proximity to the transmitter apparatus;

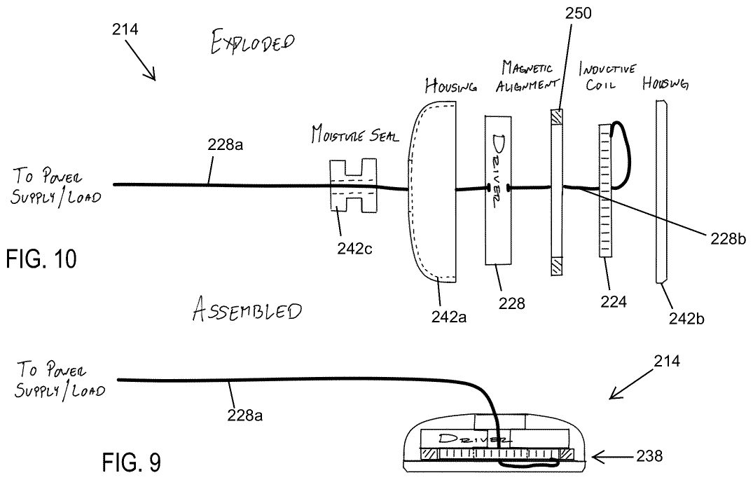

FIG. 9 is a side elevation view of another embodiment of a transmitter apparatus;

FIG. 10 is an exploded view of the transmitter apparatus of FIG. 9;

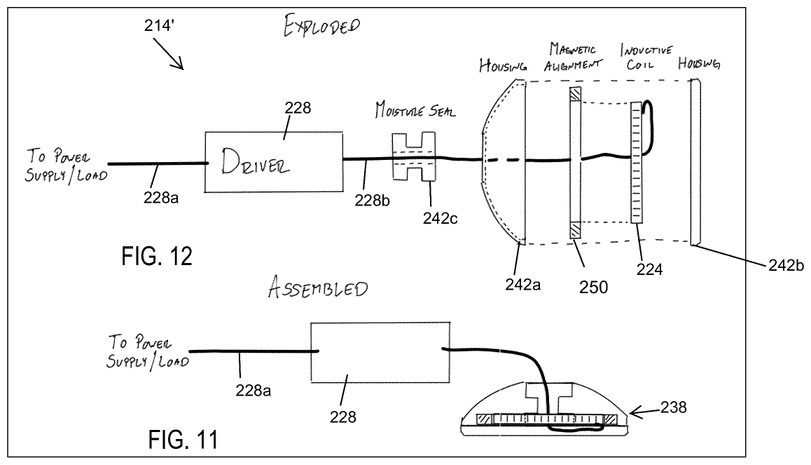

FIG. 11 is a side elevation view of a third embodiment of a transmitter apparatus with an external driver circuit;

FIG. 12 is an exploded view of the transmitter apparatus of FIG. 11;

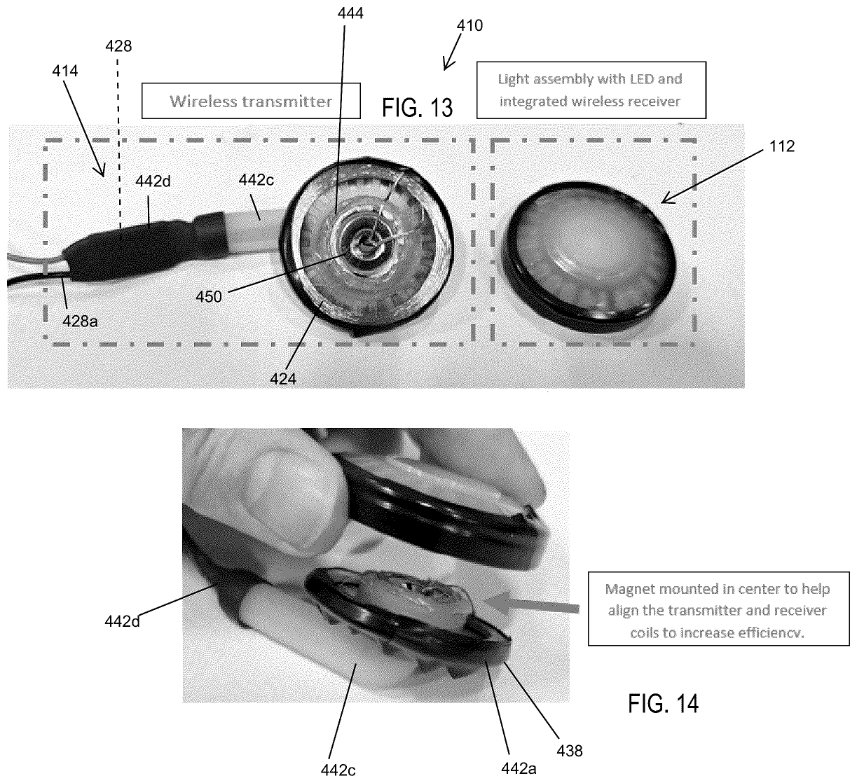

FIG. 13 is an exploded view of another embodiment of the light assembly;

FIG. 14 is an enlarged view of the light assembly of FIG. 13 illustrating the light module adjacent the transmitter apparatus;

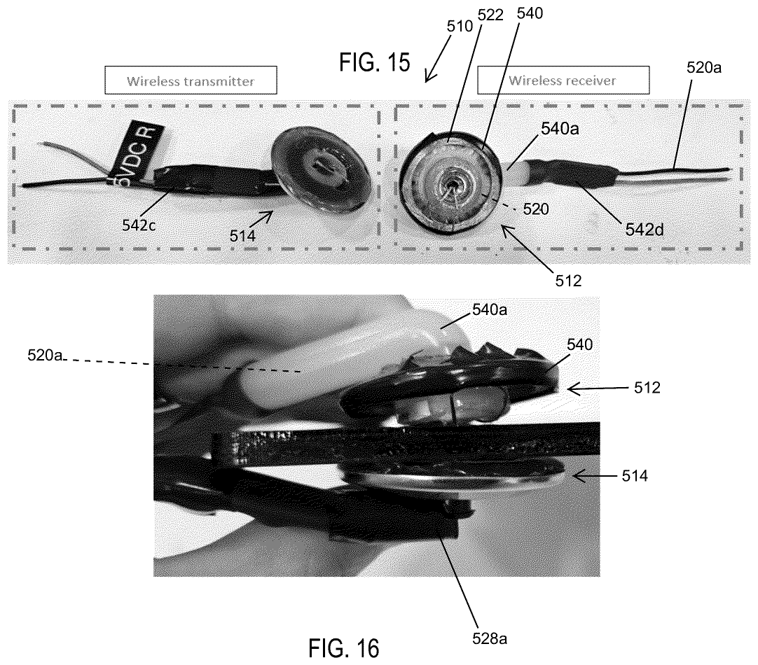

FIG. 15 is an exploded perspective view of another embodiment of the light assembly with a transmitter apparatus and a light module with a tethered receiver apparatus;

FIG. 16 is an enlarged view of the light assembly FIG. 15 illustrating the receiving apparatus and transmitting apparatus located on the opposed sides of a mounting surface positioned there between;

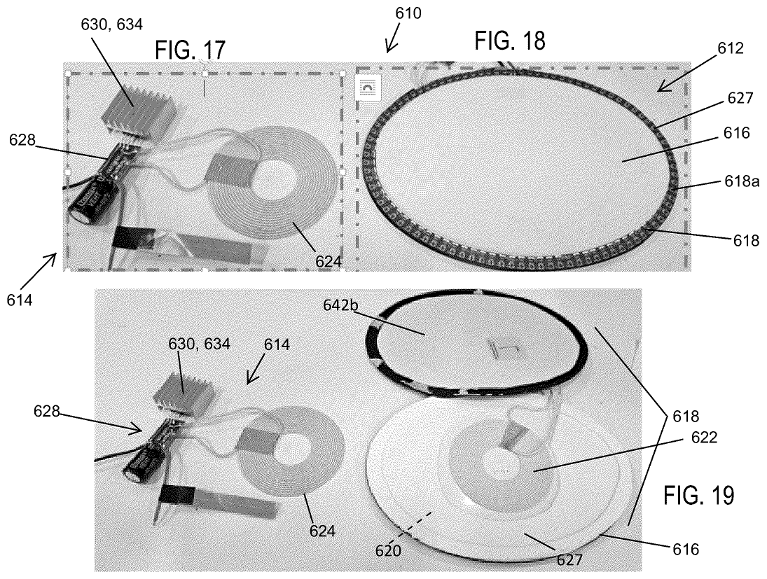

FIG. 17 is an exploded perspective view of another embodiment of a transmitter apparatus without the transmitter housing;

FIG. 18 is a perspective view of another embodiment of a light module;

FIG. 19 is an exploded perspective view of the transmitter apparatus of FIG. 17 and the back of the light module of FIG. 18;

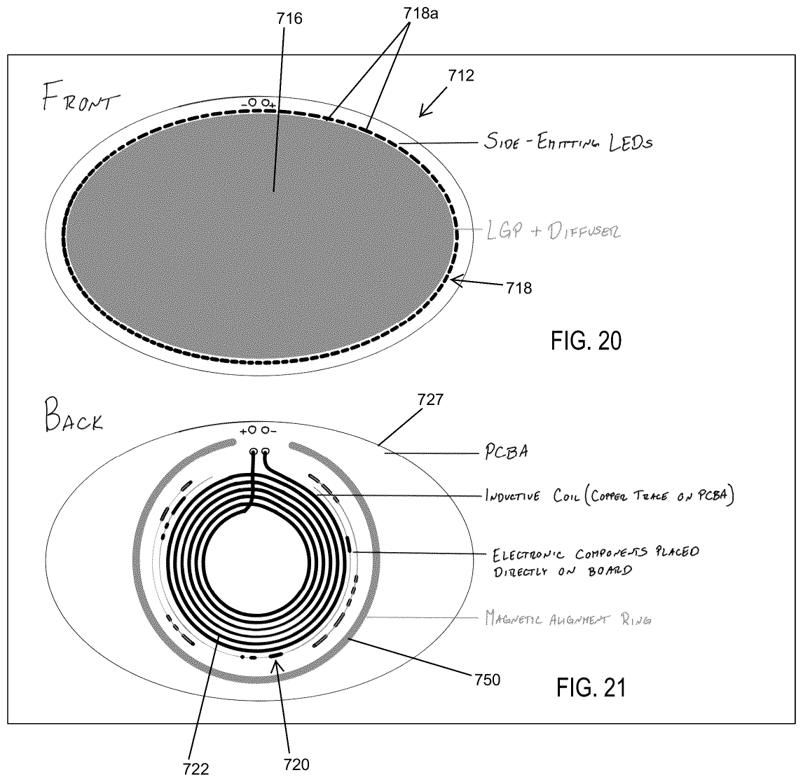

FIG. 20 is a front plan view of yet another embodiment of a light module without a housing; and

FIG. 21 is a back plan view of the light module FIG. 20.

### DESCRIPTION OF THE PREFERRED EMBODIMENTS

Referring to FIG. 1, the numeral 10 designates a light assembly that is configured to mount to a mounting surface and can be mounted without the need for drilling wiring holes through the mounting surface. As will be fully described below, light assembly 10 includes a light module 12 and a transmitter apparatus 14, which are mounted to opposed sides of the mounting surface and are configured to wirelessly power the light source in the light module 12. However, it should be understood that in some applications transmitter apparatus 14 may be mounted in the mounting surface or on the mounting surface where it forms a base for mounting the light module, though without wires extending there between.

As best seen in FIG. 1, light module 12 includes a light-transmitting surface 16, a light source 18 supported relative to the light-transmitting surface 16 to direct to the light-transmitting surface 16 when the light source is powered, and an electrical circuit 20 in electrical communication with the light source 18 to direct current to the light source 18. The light module 12 may also include a wireless power receiving coil 22 that is in electrical communication with the electrical circuit 20 and is for receiving wireless power from a wireless power transmitting coil 24 supported in the transmitter apparatus and supported on the opposed side of the mounting surface and separately from the electrical circuit 20 and the wireless power receiving coil 22. Thus, when the wireless power receiving coil 22 is in close proximity to the wireless power transmitting coil 24, the electrical circuit 20 will direct current to the light source 16. Close proximity refers to when the wireless power receiving coil is within 0 to 6 inches (in) of the wireless power transmitting coil. As would be understood, the range of what defines close proximity may vary depending on the circuit design in combination with the size or number of coils in the transmitting and wireless power receiving circuits, and the mounting surface thickness and/or material, for example, wood, plastic, glass, etc.

Electrical circuit 20 may comprise an LC circuit with a capacitor 20a and an inductive coil 20b, which is formed by the wireless power receiving coil 22. As would be understood, capacitor 20a is charged when voltage is applied to the LC circuit via coil 20b when the wireless receiving coil 22 is in close proximity to the wireless power transmitting coil 24. To convert the alternating current that is generated by the LC circuit, electrical circuit 20 also includes an AC to DC converter 26, often referred to as a bridge rectifier (circuit or solid state device), so that DC voltage/current may be applied to light source 18. Electrical circuit 20, wireless receiving coil 22, and the AC to DC converter 26 may be all commonly mounted on or formed on a circuit board 27, as will be more fully described below, in reference to light module 712.

The wireless power transmitting coil 24 is located in transmitter apparatus 14 and is powered by a driver circuit 28, also located in transmitter apparatus 14, and which includes electrical leads 28a that extend from transmitter apparatus 14 for coupling to an external power source, such as an AC or DC power source.

As best seen in FIGS. 4 and 5, depending on the power source, driver circuit 28 of transmitter apparatus 14 may have an AC to AC converter 30 to vary the voltage from an AC power supply 32 or a DC to AC inverter 34 to convert the DC power from the DC source 36 to a more suitable voltage for driving the light source, for example LEDs. Similar to electrical circuit 20, driver circuit 28 may also comprise an LC circuit with a capacitor and an inductive coil, which may be formed by wireless power transmitting coil 24.

Optionally, the light module 12 may include a rechargeable battery so that when the light module is moved away from the transmitter apparatus, the light will still be powered, at least for the life of the battery. This may be suitable in a number of applications, for example, when the mounting surface moves with the light module and the transmitter apparatus remains stationary on the other side of the mounting surface. For example, in a drawer the light module may mount to the back of the drawer. When the drawer is pulled open, the light module no longer receives inductive power from the transmitter (which is mounted to back of the cabinet structure, for example) and, instead, can rely on the battery. Once the drawer returns, the battery can be recharged by the transmitting coil.

In the illustrated embodiment, light source 18 comprises a plurality of LEDs 18a. As would be understood, the arrangement of the LEDs 18a may vary. For example, as described in reference to light module 112, a single LED may be used and located behind the light emitting surface. Referring again to FIG. 1, in the illustrated embodiment, the light source comprises LEDs 18a that are arranged around the perimeter of the light module 12 and, more particularly, around the perimeter edge of the light-emitting surface 16, as will be fully described below.

For example, light-emitting surface 16 may be formed by a light guide plate (LGP) optionally with a diffuser, such as a coating or thin film on the light guide plate to diffuse the light as it passes through the light guide plate. Alternately, the light guide plate may be formed with an additive during molding to diffuse the light. Optionally, the LEDs 18a may be located at the perimeter edge of the light guide plate so that light is directed to and from the light-emitting surface from the perimeter edge of the light guide plate. Further, as will be most fully described below one or more the electrical components may be commonly mounted with the LEDs on a printed circuit board to facilitate assembly and make a more compact light module.

Each of the transmitter apparatus 14 and the light module 12 may include a housing 38, 40 (FIG. 1). For example, as best seen in FIG. 3, transmitter apparatus 14 may include a housing 38 with a housing base 42a and a housing cover 42b, which when secured and sealed together form the housing 38 for transmitter apparatus 14. For example, housing base 42a and housing cover 42b may be joined together by welding, such a heat sealing, an adhesive, a snap fit coupling (such as a bayonet and receptacle coupling) with an optional gasket or compression seal there between, or fasteners (though sealant may need to be applied depending on the application).

Driver circuit 28 and wireless power transmitting coil 24 may be both commonly mounted or formed on a printed circuit board 44, which then is mounted in housing base 42a using conventional mounting methods and then covered and sealed in housing base 42a by housing cover 42b. To couple to the external power source, as noted, circuit 28 includes electrical leads 28a that extend through an opening formed in housing base 42a to couple to the external power source 32 or 36, as noted above. To seal the opening around the leads 28a, transmitter apparatus 14 may include a seal 42c, such as a plug or grommet seal, that extends into housing base 42a, and which also forms a strain relief for the leads 28a

When circuits 20 or 28 are mounted to circuit boards, the respective coils (wireless power receiving coil and/or wireless power transmitting coil) may be formed on the circuit board, such as by a copper trace. Further, the coils may be formed on one side of the circuit board while the electrical or driver circuit, as well as other electrical components, may be mounted on or adjacent the opposed side of the circuit board, such as shown in FIG. 3 and also in reference with light module 712.

Optionally, the light assembly 10 may include an alignment device to align the wireless power receiving coil with the wireless power transmitting coil. For example, each of transmitter apparatus 14 and light module 12 may include one or more magnets 50 to align the wireless power receiving coil 22 with the wireless power transmitting coil 24. As best seen in FIGS. 2 and 3, magnets 50 may be mounted to the circuit board, for example at the circuit board's perimeter and, further, may be arranged in an array around the circuit board's perimeter. For example, the magnets 50 may be arranged in a circular arrangement, either spaced or adjacent each other such as shown in FIG. 6, to form a magnetic ring. Similarly, as will be described in reference to light module 112, light module 12 may include a corresponding arrangement of magnets or a magnetic ring or loop to facilitate alignment of the respective coils.

Referring to FIGS. 6-8, the numeral 110 designates another embodiment of the light assembly. Light assembly 110 similarly includes a light module 112 and a transmitter apparatus 114. In this embodiment, the light module 112 may include a single light source, such as an LED, that is mounted behind the light-transmitting surface. In the illustrated embodiment, light-emitting surface 116 comprise a domed lens formed from plastic with an optional diffuser, such as a coating or film to diffuse the light. The lens may also or instead include regions of different opacity or curved or angled surfaces to form a desired light pattern.

In the illustrated embodiment, light module 112 and transmitter apparatus 114 each have a round cylindrical housing 140, 138, which house their respective components in a sealed manner such as described above. In the illustrated embodiment, the driver circuit and transmitting coil of the transmitter apparatus are all housed and sealed in housing 138. Similarly, the electrical circuit, light source, and receiving coil of the light module are all enclosed and sealed in housing 140. For further details of the electrical circuit, the driver circuit, and other electronic or electrical components, of light module and of transmitter apparatus reference is made the above embodiment.

Referring to FIGS. 9 and 10, the numeral 214 designates another embodiment of the transmitter apparatus. Similar to transmitter apparatus 14, transmitter apparatus 214 includes a wireless power transmitting coil 224 and driver circuit 228, but without a circuit board. Similar to the previous embodiments, wireless power transmitting coil 224 and driver circuit 228 are enclosed and sealed in a housing 238, which is similarly formed from a housing base 242a and a housing cover 242b. Transmitter apparatus 214 may include an array of magnets or a magnetic ring or loop 250 to help align the wireless power transmitting coil 224 with the wireless power receiving coil of the light module.

Driver circuit 228 is electrically coupled to the power source via electrical leads 228a, which extend through an opening in housing base 242a to couple to the power source as described above in reference to FIGS. 4 and 5, and is electrically coupled to wireless power transmitting coil 224 via electrical leads 228b. Leads 228a also extend through an opening in housing base 242a and sealed on the opening via a seal 242c, such as a plug seal or grommet seal. For further details of the joining of housing base 242a to housing cover 242b reference is made the first embodiment.

Referring to FIGS. 11 and 12, the numeral 214′ refers to another embodiment of the transmitter apparatus 214 in which the driver 228 is mounted externally of housing 238. Thus, in this embodiment, leads 228b are sealed in housing base 242a by seal 242c, which as noted may also form a strain relief for the leads.

Referring to FIGS. 13 and 14, the numeral 410 generally designates another embodiment the light assembly with light module 112 and a modified transmitter apparatus 414. For details of light module 112 reference is made to the above description.

Transmitter apparatus 414 is a similar construction to previous embodiments in that it includes a driver circuit 428 and a wireless power transmitting coil 424, which is coupled to the driver circuit 428 via leads 428b. In the illustrated embodiment, transmitter apparatus 414 includes a centrally located magnet 450 for aligning the wireless power transmitting coil 424 with the wireless power receiving coil of the light module 112, which may be commonly mounted with wireless power transmitting coil 424 to a circuit board 444.

In the illustrated embodiment, transmitter apparatus 414 includes a 90° wire exit for leads 428a to seal and guide leads 428a, transmitter apparatus 414 includes an L-shaped tube 442c, such as a silicone tube or a plastic tube, including PVC or ABS, for example, which is molded or glued or otherwise attached to housing base 442a of housing 438 about the exit opening. Tube 442c directs the electrical leads 428a at a generally 90° orientation relative to housing 438 as they exit housing 438. Optionally, tube transmitter apparatus 414 may include an additional strain relief portion 442d (in addition to the tube) between tube 442c and electrical leads 428a. For example, the strain relief portion 442d may be formed from a shrink wrap tube applied over a distal end portion of the tube 442c and portions of the leads extending from the tube 442c.

Referring to FIGS. 15 and 16, light assembly 510, which also includes a light module 512 and a transmitter apparatus 514, includes an external light source (not shown). For example, the light source may comprise a strip of LEDs or just a single light or anything in between. Transmitter apparatus 514 may be similar to transmitter apparatus 414 but may omit the tube 442c and, instead, include a shrink wrap tube to seal and provide strain relief to the leads; therefore, reference is made to the above embodiment for details of transmitter apparatus 514.

In the illustrated embodiment, the light source of light module 512 is located externally of the light module housing 540, while the electrical circuit 520 and wireless power receiving coil 522 are located and sealed within housing 540. Similar to the driver circuit of the previous embodiment, electrical circuit 520 includes electrical leads 520a, which exit housing 540 through an opening formed in the housing 540. Electrical leads 520a are sealed at their exit from housing by a seal 540a, such as a tube, similar to tube 442, which allows a 90° exit of the electrical leads 520a from housing 540 for coupling to the light source remote from light module 512. Optionally, similar to transmitter apparatus 414, a strain relief 542d (FIG. 16), such as a shrink wrap tube, may be mounted about the distal end of tube 540a and over a portion of the leads 520a as they exit the tube 540a.

For further details and optional mounting arrangements of electrical circuit 520 and wireless transmitting coil 522, reference is made to the above embodiments.

Referring to FIGS. 17-19, the 610 designates yet another embodiment of a light assembly, which includes a light module 612 and a transmitter apparatus 614, both of which are illustrated without their respective housings. In the illustrated embodiment, the wireless power receiving coil 622 is integrated directly into a LED light assembly 618 of the light module 612.

LED light assembly 618 includes a circuit board (PCBA) 627 on which the LEDs 618a and electrical circuit 620 are mounted, and a light-emitting surface 616, such as a light guide plate, which is also mounted to the circuit board 627. Similar to light module 12, LEDS 618a are side or edge mounted adjacent the perimeter edge of the light guide plate to direct light into the edge of the light guide plate. Wireless power receiver coil 622 is mounted to the back of circuit board 627 and is enclosed in the LED light assembly 618 by a cover 642b, which seals the receiving coil 622 in the light module 612. Thus, a thin planar light panel module is formed that can be powered inductively by the transmitter apparatus 614 when it is close proximity to the transmitter apparatus 614.

Similar to the previous embodiments, transmitter apparatus 614, which is shown only in exploded format in the figures, includes a wireless power transmitting coil 624, a driver circuit 628, which is electrically coupled to the wireless power transmitting coil 624 and also to an AC to AC converter 630 or a DC to AC inverter 634, depending on the power source, similar to the first embodiment. For details not specifically mentioned herein reference is made to the above embodiments.

Referring to FIGS. 20 and 21, the numeral 712 generally refers to another embodiment of the light module, though the details of the housing are omitted. For details of optional housings, reference is made to the above embodiments.

In the illustrated embodiment, light module 712 includes a light source 718, such as LEDs 718a, an electrical circuit 720, a wireless power receiving coil 722, and other electronic components, such as the AC to DC converter, are all commonly mounted to a circuit board 727. For example, the light source 718 may be mounted to one side of the circuit board 727, with the electrical circuit 720, wireless transmitting coil 722, and the other electronic components mounted to the opposed side of the circuit board 727.

The light-transmitting surface 716 is located adjacent the LED side of the circuit board. Similar to the previous embodiments, light-transmitting surface 716 may comprise a light guide plate that is located so that the LEDs 718a surround the perimeter edge of light guide plate to direct light inwardly to the plate for redirection by the plate through its light-emitting surface 716.

Light module 712 may similarly include an alignment device, such as a magnetic augment ring 750, which facilitates alignment of the wireless power receiving coil 722 with the transmitting coil of the respective transmitter apparatus.

While several embodiments of the light assembly have been described herein, it should be understood that features of one embodiment may be combined with one or more features of another embodiment. Further where specific details are omitted for a feature of any one of the embodiments, reference is made to the corresponding feature in the other embodiment or embodiments for further detail.

We claim:

1. A light module comprising:
a light-transmitting surface;
a light source supported relative to said light-transmitting surface to direct to said light-transmitting surface when said light source is powered;
an electrical circuit in electrical communication with said light source to direct current to said light source; and
a wireless power receiving coil in electrical communication with said electrical circuit, said wireless power receiving coil for receiving wireless power from a wireless power transmitting coil supported remotely from said electrical circuit wherein when said wireless power receiving coil or loop is in close proximity to the wireless power transmitting coil or loop said electrical circuit will direct current to said light source.

2. The light module according to claim 1, further comprising a housing, said housing including said electrical circuit.

3. The light module according to claim 2, said housing further including said light emitting surface.

4. The light module according to claim 1, wherein said light emitting surface is provided by a light guide plate (LGP).

5. The light module according to claim 1, further comprising a circuit board, wherein said electrical circuit and said wireless power receiving coil are supported or formed on said circuit board.

6. The light module according to claim 5, wherein said wireless power receiving coil comprises a copper trace wireless power receiving coil printed on said circuit board.

7. The light module according to claim 1, wherein said light source comprises a plurality of LEDS.

8. The light module according to claim 7, wherein when said light emitting surface is provided by a light guide plate (LGP), said light guide plate having an edge, and said plurality of LEDS are mounted adjacent said edge of said light guide plate.

9. The light module according to claim 1, further comprising an alignment device to align said wireless power receiving coil with the wireless power transmitting coil.

10. The light module according to claim 1, wherein said electrical circuit comprises an LC circuit with a capacitor and said wireless power receiving coil.

11. A light module comprising:
a housing, said housing having a light emitting surface;
a light source supported and sealed in said housing for directing light through said light emitting when said light source is powered;
an electrical circuit electrically coupled to said light source for directing current to said light source, said circuit sealed in said housing; and
a wireless power receiving coil electrically coupled to said electrical circuit, said wireless power receiving coil supported and sealed in said housing for receiving wireless power from a wireless power transmitting coil supported exteriorly of said housing wherein when said wireless power receiving coil is in close proximity to the wireless power transmitting coil said electrical circuit will direct current to said light source.

12. The light module according to claim 11, wherein said light emitting surface is provided by a light guide plate (LGP).

13. The light module according to claim 11, further comprising a circuit board, wherein said electrical circuit and said wireless power receiving coil are supported or formed on said circuit board.

14. The light module according to claim 11, wherein said wireless power receiving coil comprises a copper trace wireless power receiving coil printed on said circuit board.

15. The light module according to claim 11, wherein said light source comprises a plurality of LEDS.

16. The light module according to claim 15, wherein when said light emitting surface is provided by a light guide plate (LGP), said light guide plate having an edge, and said plurality of LEDS are mounted adjacent said edge of said light guide plate.

17. The light module according to claim 11, further comprising an alignment device to align said wireless power receiving coil with the wireless power transmitting coil.

18. The light module according to claim 17, wherein said alignment device comprises a magnet.

19. The light module according to claim 11, wherein said electrical circuit comprises an LC circuit with a capacitor and said wireless power receiving coil and an AC to DC converter.

20. A light assembly comprising:
a light module comprising:
a light-transmitting surface;
a light source supported relative to said light-transmitting surface to direct to said light-transmitting surface when said light source is powered;
an electrical circuit in electrical communication with said light source to direct current to said light source;
a wireless power receiving coil in electrical communication with said electrical circuit, said wireless power receiving coil for receiving wireless power from a wireless power transmitting coil supported remotely from said electrical circuit wherein when said wireless power receiving coil or loop is in close proximity to the wireless power transmitting coil or loop said electrical circuit will direct current to said light source; and
a transmitter apparatus having a driver circuit for electrically coupling to a power source, and said transmitter apparatus further having a wireless power transmitting coil electrically coupled to said driver circuit, and when said wireless power receiving coil is in close proximity to said wireless power transmitting coil and said driver circuit of said transmitter apparatus is coupled to a power source, said electrical circuit of said light module will direct current to said light source.

21. The light assembly according to claim 20, wherein said electrical circuit comprises an LC circuit with a capacitor and said wireless power receiving coil.

22. The light assembly according to claim 20, said light module further comprising a housing, said housing including said light emitting surface and said electrical circuit.

23. The light assembly according to claim 22, wherein said light source, said electrical circuit, and said receiving circuit are sealed in said housing.

24. The light assembly according to claim 20, wherein said light emitting surface is provided by a light guide plate (LGP).

25. The light assembly according to claim 24, said light module further comprising a circuit board, wherein said electrical circuit and said wireless power receiving coil are supported or formed on said circuit board.

26. The light assembly according to claim 20, wherein said light source comprises a plurality of LEDS, said light emitting surface is provided by a light guide plate (LGP), said light guide plate having an edge, and said LEDS are mounted adjacent said edge of said light guide plate.

27. The light assembly according to claim 20, said transmitter apparatus further comprising a transmitter housing, said transmitter housing supporting and enclosing said driver circuit and said wireless power transmitting coil.

28. The light assembly according to claim 27, wherein said driver circuit includes an electrical lead extending from said transmitter housing to couple to an external power source, and said housing including a moisture seal about said electrical lead.
